(19) United States
(12) Patent Application Publication
(10) Pub. No.: US 2018/0286282 A1
(43) Pub. Date: Oct. 4, 2018

(54) MATHEMATICS LEARNING GAMIFIED PLATFORM, SYSTEM AND METHOD FOR AN ELECTRONIC DEVICE

(71) Applicant: Mauro Jorge Guerreiro Figueiredo, Vilamoura (PT)

(72) Inventor: Mauro Jorge Guerreiro Figueiredo, Vilamoura (PT)

(21) Appl. No.: 15/942,790

(22) Filed: Apr. 2, 2018

Related U.S. Application Data
(60) Provisional application No. 62/481,161, filed on Apr. 4, 2017.

(51) Int. Cl. G09B 23/02; G09B 7/077; G06F 17/30; G09B 7/02

(52) U.S. Cl. CPC G09B 23/02; G09B 7/02; G06F 17/30873; G09B 7/077

(57) ABSTRACT

The present invention relates to the design and development of a learning game platform, system and method that is implemented in an electronic device to promote autonomous work and active learning, integrating all students, with self and peer assessment, supported by instructional videos that can be used for any subject/course implemented on electronic devices for the teaching and learning of mathematics, languages, physics or any other subject. Students can use this in the classroom or outside the classroom in an online, blended or flipped learning setup to study and solve problems, combining analog input and digital outputs.

The innovative part of this platform is that it integrates: analog input; a gamification scheme; videos; levels of problems and levels of instructional videos, organized in a video-book; digital-portfolio; self-assessment and peer-assessment.

Different difficulty levels of problems and of video instructional resolutions, self and peer-assessment is implemented to include all students and promote autonomous and active learning in a gamified platform to motivate students.

The application of the present invention can be used for online, mobile, blended and flipped learning. Teachers can follow what students are doing in another back office application, which is also part of the system of the present invention.

The present invention can be implemented also on electronic devices such as smartphones, tablets, etc. allowing students to use this it in the classroom or outside the classroom in a blended learning model to solve problems.

The learning gamified platform, system and method, for an electronic device executing an application, comprises a server for a reading medium and storing user information, scores and user progress and e-portfolio within a play and learn app platform. The server communicates through the Internet with electronic devices having Internet access operated by at least one player. Registration means allows the player to register with and log on to the play and learn app. Also the app allows the teachers to follow the performance of the players and to improve some aspects of the teaching program in a given classroom.

### FIELD OF THE INVENTION

The present invention relates to the design and development of a learning platform, system and method that is implemented in an electronic device for the teaching and learning of mathematics promoting autonomous and active learning.

### BACKGROUND OF THE INVENTION

Results from recent years of the Program for International Student Assessment (PISA), show that students from many countries do not attain the baseline proficiency Level 2 in mathematics. It means that in the best of the cases, low achievers students can extract relevant information from a single source and can use basic algorithms, formulae or procedures to solve problems involving whole numbers. This is a problem that many students are facing and that also means reducing their future perspectives because they cannot continue their studies in science and/or engineering because of the lack of mathematics knowledge.

Regardless the controversy over PISA tests results, this situation calls for actions aiming at improving instruction strategies for teaching and learning mathematics.

This invention was designed and developed looking for improving mathematical performance and achievements, but it can be used for any other discipline, for all students including also those in the PISA share of low achievers and the top performers. This invention extends the traditional learning environment to a virtual classroom setting that will keep students connected for learning.

We want to take advantage of mobile devices for teaching and learning. The recent availability of smartphones and tablets with increased processing power and usability, accessible on a large scale, allow an exponential expansion of social and participative web technologies. However, in many countries teachers and students do not use mobile devices for teaching and learning purposes. It is also important to note that these students are the generation of digital games and social networks. In this context it is wise to consider the integration of digital media and mobile devices (iPad, iPod, tablets, smartphones), allowing students to set personal goals, to manage educational content and to communicate with others in the right context. However, according to the EU Commission initiative Opening Up Education (25 Sep. 2013), between 50% and 80% of students in EU countries never use digital textbooks, exercise software, podcasts, simulations or learning games. Most teachers at primary and secondary level do not consider themselves as ‘digitally confident’ or able to teach digital skills effectively, and 70% would like more training in using ICTs.

This application will contribute for the implementation of a blended model for teaching and learning mathematics that will accommodate gaming mechanics that it is two-fold: complexity and detail. It has three different levels of problems complexity: beginners, intermediate and advanced. On the other hand each problem has two levels of explanations/resolutions: detailed and concise.

In this way, all students are accommodated in a learning environment centered in the student. The low-achieving students that may struggle to learn the materials covered in class, can study and repeat the materials as many times as they may need to learn. Students will have access to complex problems and activities that may provide additional stimulation for top performer students. Teachers will also be more confident to give homework activities to their students. It is known that it is important to assign homework, to help struggling or underachieving students to learn the material covered in class, to ensure that the material is stored in students' long-term memory, or to provide additional stimulation for high performers. But homework can be particularly burdensome for disadvantaged students. Their parents' may not have the skills to help them, they may not have the resources to support them on private lessons. We aim at providing the same support for all the students so that we can contribute to weaker the relationship between students' socio-economic background and learning performance.

In recent years, gamification has become a hot topic for researching as an important element to promote motivation and engagement in the learning process. Hsu, Chang & Lee (2013) defined gamification as the incorporation of game mechanics into nongame settings, which aims to increase users' engagement of the product or service and facility certain behaviours. According with Attali and Arieli-Attali (2015) gamification relies on the argument that many traditional activities (including schools' activities and traditional learning) are not inherently interesting, that games, especially computer-games, are “fun”, and therefore introducing game-like features into these otherwise dull activities would make them more attractive (Zichermann and Linder, 2010).

Educational assessment is essential to student learning and constitutes integral part of teaching and learning process.

Self-assessment requires students to reflect on and evaluate the quality of their work and their learning. This process involves identification of strengths and weaknesses of one's work followed by the necessary revision (Andrade and Du, 2007). Peer assessment requires students to provide either feedback or grades (or both) to their peers on a product or a performance (D. Boud and N. Falchikov, 2007). Both self and peer-assessment recognizes learners as active participants in their learning process and contributes to establishing a culture of engagement and support.

Self and peer assessment promote formative learning, learners' responsibility and learners' independence. Increased level of responsibility and autonomy lifts the role of a student from passive to active, which may result in a deeper approach to learning. Self-assessment is linked with introspection and self-discovery while peer-assessment adds cooperative atmosphere to the learning. The list of advantages includes development of deeper understanding of the subject matter and fostering skills for lifelong learning crucial in knowledge societies.

This invention also motivates students to do a self and peer-assessment both inside and outside the classroom to promote autonomous and active learning. Wood, Teräs, Reiners and Gregory (2013) consider that coupled with new approaches in education and particularly gamification technology presents opportunities for new forms of assessment that may provide a more accurate picture of students' achievements. Indeed, traditional, one-off assessment activities no longer provide suitable structures for assessing student learning, and the game-based mechanisms not only provide improved engagement but also provide the opportunity for a range of new assessment of authentic learning tasks.

Document US2015/0010894 A1 describes a system and method for authoring and delivering online educational courses. This document describes a central computing system with details related to a desired subject matter for which the course is to cover, a total duration of time allotted for the user to complete the course, and a minimum number of total points required for the user to receive a passing score upon completion of the course. When compared to the present invention, the learning platform described in the document US2015/0010894 A1 does not include: (i) video tutorials, (ii) problem solving; (iii) worksheets with different levels of difficulty, (iv) self-assessment; (v) peer-assessment; (vi) and it does not allow analog input. The technical effect conferred by these features is that it allows to integrate all students in a student centered platform that promote autonomous and active learning with video tutorial and problem solving including self and peer-assessment.

Document U52016/303480 A1 describes a learning game platform to provide educational games to facilitate learning. It provides a plethora of games teaching additional reading and math skills on different academic levels. This learning game platform is appointed to be utilized to successfully teach and reinforce basic skills in reading and math. When compared to the present invention, the learning platform described in the document US2016303480A1 does not include: (i) video tutorials, (ii) problem solving; (iii) worksheets with different levels of difficulty, (iv) self-assessment; (v) peer-assessment; (vi) and it does not allow analogue input. The technical effect conferred by these features is similar to the one described above, i.e. is it allows to integrate all students in a student centered platform that promote autonomous and active learning with video tutorial and problem solving including self and peer-assessment.

### SUMMARY OF THE INVENTION

The present invention relates to the design and development of a learning gamified platform, system and method that is implemented in an electronic device for the teaching and learning of mathematics.

The system of the present invention for an electronic device comprises a server for reading medium and storing the user information, progress, scoring and other relevant data of the user, a communication tool for the server communication via Internet with at least one electronic device, at least one electronic device with Internet access, said electronic device having installed the learning gamified platform having registration means for the registration and definition of at least one user's profile and skill level and setting, recording and displaying the user's current and historic score, e-portfolio and performance.

The innovative part of this platform is that it integrates:
Analog input—students solve problems with pen and paper and using the electronic device it is taken a photo that scans the student answer into the platform.
A gamification scheme is implemented to motivate students for learning
Instructional Videos to provide feedback and for learning
Different difficulty levels of problems and
Different levels of explanation videos are available to integrate all students and in this way students that are low performers can start with beginner levels of problems and watch detailed instructional videos, as well as, more advanced students can be motivated by learning by solving advanced problems and watch concise instructional videos.
Self and peer-assessment to promote learning and auto-regulation.

The learning platform of the system of the invention is designed for mathematics, but can be used for any discipline, teaching and learning application comprising a client application and a server providing services to store and maintain the data of students.

### BRIEF DESCRIPTION OF THE DRAWINGS

FIG. 1 represents an overview of the relational database model that supports the platform of this invention.

FIG. 2 shows that state diagram of the system.

FIG. 3 shows the pseudo code for the different tasks that the system executes in the state 3 to show current question and alinea.

FIG. 4 shows the state diagram expanded to solve open problems and self-assessment.

FIG. 5 presents the student registration in the platform app. The student introduces the complete name, nickname, country, school name, email and password to register in the platform.

FIG. 6 represents the screen where the student logins in the system. The first time the student enters in the system he/she is asked to validate the email in the platform using an email validating code that is sent to the email.

FIG. 7 represents the step where the student select a group to join that is supervised by a teacher by entering the group code that is provided by the teacher, or the student can join an “open” subject. In this case, the student selects from a dropdown menu the open subjects that are available. In this case, the student is not supervised by a teacher. After adding a group code or joining a subject the student can progress to the working environment of the student application.

FIG. 8 represents the relational database that is in the server, to support the students' access to subjects contents by adding themselves to a group that is associated to a subject, or by joining a subject that is open to everyone and not supervised by a teacher. In this way, students can attend subjects or belong to a group that is studying a subject.

FIG. 9. Students can access the configuration options menu by clicking in number 1; 2—button to join an open subject; 3—button to add a group code to join a group/classroom of a subject that is supervised by a teacher; 4—option to have access to students account in the platform where he can change the name, nickname, country and school; 5—option where student can change his password; 6—option to logout from the platform app.

FIG. 10. The student chooses the subject to study by clicking in the dropdown to select the subject to study (number 1); the chapter of study by clicking in the dropdown number 2 and the sub-chapter of interest by clicking in number 3. The student selects worksheets with tutorials and/or questions of problems to solve (clicking button number 4) or he may assess a peer (clicking button number 5). There are worksheets available with different degrees of difficulty: beginner (color green—number 6), intermediate (color yellow—number 7), and advanced (color red—number 8).

FIG. 11. Each subject is organized in a hierarchy structure with chapters, sub-chapters and the worksheets at the bottom. In this way, students can easily find worksheets related to matter of interest to study.

FIG. 12. Student can select the top 10 ranking (clicking button number 1) for the school, country or world classification by clicking the dropdown button 2. The list of students in the rank is shown in the number 3 area.

FIG. 13. Students can use the chat (clicking 1) to collaborate in the group, school, country or globally (clicking in the dropdown button 2). Students can send messages by clicking in number 3 and messages are shown in zone 4.

FIG. 14. The student solves problems from the worksheet. Number 1—camera icon that the student uses to take a snapshot of the problem resolution made with pen and paper; 2—navigate to next or previous question; 3—navigate to next or previous alinea; 4—return to the working environment; 5—go to the chat to collaborate with other students; 6—progression bar; 7—student can zoom in and out the statement of the question.

FIG. 15. The student takes a snapshot of the problem resolution by clicking in 1; if clicking in 2 then the student returns to the worksheet working environment and problem solving is canceled.

FIG. 16. By clicking in 1, the student confirms and the snapshot of the problem resolution is uploaded to the server; if clicking in 2 then the student returns to the screen of FIG. 15 and can take another snapshot; and if clicking in 3 the student returns to the worksheet working environment.

FIG. 17. After uploading the resolution of a problem (number 1) the student is going to do the self-assessment using the instructions for evaluation (number 2). The student introduces the points (number 3) that are added to its game and confirms by clicking in 4 to upload those points to the server. Button to toggle question/evaluation view (number 5). Button to watch the instructional video (number 6).

FIG. 18. The student returns to the worksheet working environment and the problem 1 is ticked as solved (number 1), the progression bar is updated (number 2) and the student can see now a detailed and/or concise video with the problem resolution (number 3).

FIG. 19. Instructional video player. 1—return button; 2—play/pause button; 3—sound volume; 4—position in the video; 5—playing at position; 6—total duration of the video.

FIG. 20. The student completes a worksheet of problems. Now the student can evaluate the same worksheet of a peer.

FIG. 21. When the student completes solving a worksheet then the student can evaluate the same worksheet of a peer.

FIG. 22. The student evaluates a peer anonymously. 1—The peer resolution of this problem; 2—instructions for evaluation; 3—points for the peer game; 4—confirm button to upload the peer-assessment.

FIG. 23. The worksheet can have multiple-choice questions.

FIG. 24. The worksheet can have any number of questions. Each question can have any number of sub-questions. It is possible to combine tutorials, open and multiple choice question by any order. Tutorials are identified in the navigation panel with a T.

FIG. 25. The worksheet can be assigned to a location with an area of activation (number 1). Using Augmented Reality when the student is inside the area of influence of the worksheet, it is activated and the student can view the tutorials or solve problems that can be related to the place where it is located.

FIG. 26. The platform for teachers with its main options.

FIG. 27. The teacher can create (number 1), edit (number 2) or delete (number 3) chapters of a subject that is selected using the dropdown (number 4).

FIG. 28. The teacher can create (number 1), edit (number 2) or delete (number 3) sub-chapters of a subject that is selected using the dropdown (number 4).

FIG. 29. The teacher can create (number 1), edit (number 2) or delete (number 3) worksheets with problems or tutorials with three levels of difficulty: beginner, intermediated and advanced that is selected using the dropdown (number 4).

FIG. 30. The editor where the teacher can edit/upload questions and sub-questions to the worksheet. 1—Question statement; 2—Evaluation instructions. The teacher can create (number 3), edit (number 4) or delete (number 5) questions. The teacher can create (number 6), edit (number 7) or delete (number 8) sub-questions. 9—Button to watch the instructional video.

FIG. 31. The teacher can create (number 1), edit (number 2) or delete (number 3) groups, selected using the dropdown (number 4), for a subject. Students register using the group code.

FIG. 32. The teacher can see the e-portfolio of the student. 1—problem resolution of student displayed in number 6; 2—instructions for evaluation; 3—navigate to previous student of the group; 4—navigate to next student of the group; 5—self-assessment points; 6—name of current student of the group; 7—peer-assessment made by the student indicated in number 8.

### DETAILED DESCRIPTION OF THE INVENTION

The present invention relates to the design and development of a learning gamified platform, system and method that is implemented in an electronic device for the teaching and learning of mathematics.

The present invention can be implemented also on electronic devices such as smartphones, tablets, etc. allowing students to use this it in the classroom or outside the classroom in a blended learning model to solve problems.

The learning game platform, system and method, for an electronic device executing an application, comprises a server for a reading medium and storing user information and scores and user progress within a play and learn app platform. The server communicates through the Internet with electronic devices having Internet access operated by at least one player. Registration means allows the player to register with and log on to the play and learn app. Also the app allows the teachers to follow the performance of the players and to improve some aspects of the teaching program in a given classroom.

When students have difficulty in solving a problem they can watch the video resolution of it. In this way, we want to provide the same opportunities to low-achieving students that may struggle to learn the materials covered in class. Students have also access to complex problems that may provide additional stimulation for top performer students. Thus, the present invention provides a platform, system and method that is capable of accommodating students with different mathematic skills.

The system of the present invention for an electronic device comprises, a server for reading medium and storing the user information, progress, scoring and other relevant data of the user, a communication tool for the server communication via Internet with at least one electronic device, at least one electronic device with Internet access, said electronic device having installed the learning game platform having registration means for the registration and definition of at least one user's profile and skill level and setting, recording and displaying the user's current and historic score and performance.

The learning platform of the system of the invention is a mathematics teaching and learning application comprising a client application and a server providing services to store and maintain the data of students.

The present invention is a system and an app that has been developed to promote autonomous work in a mobile, blended or flipped learning environment.

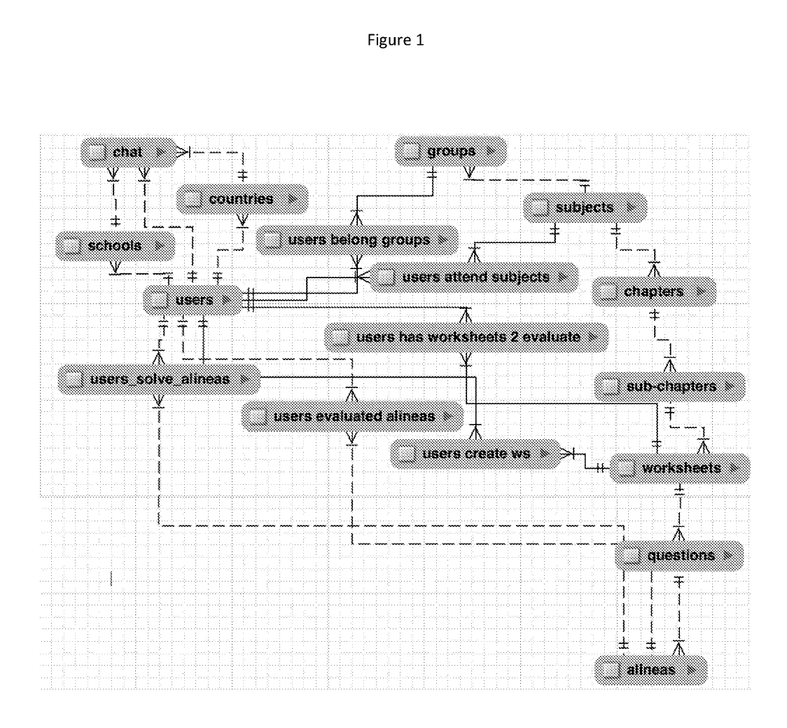

FIG. 1 represents an overview of the relational database model that supports the platform of this invention. The platform can have any number of subjects/disciplines which are organized by chapters and sub-chapters to implement the curriculum of the discipline. Users can register as students or as teachers that belong to a school in a given country. Teachers can create groups/classes of a given discipline to follow the work of their students which is available as a digital-portfolio. Students can belong to a group/classroom when the teacher uses the platform. Students attend disciplines/subjects to access worksheets. Worksheets can have instructional video tutorials or problems. Students solve questions which can have several sub-questions. It is possible to have video tutorials and questions mixed in any way. One question can have first sub-question with a video tutorial and the second sub-question can be a problem. There are no restrictions and no order is fixed. If the sub-question is a problem it can be of type open answer, multiple choice or of type true/false. There is also no limit to the number of sub-questions or to any order of type of problems or tutorials. For each problem there is always instructions for evaluation to provide feedback to students which is also used for self and peer-assessment. Students after solving the problem can also watch a detailed or concise instructional video with the resolution. When the students solves a problem then he/she makes a self-assessment using the evaluation instructions and these points go for his/her game. Students and teachers can communicate with each other using a chat.

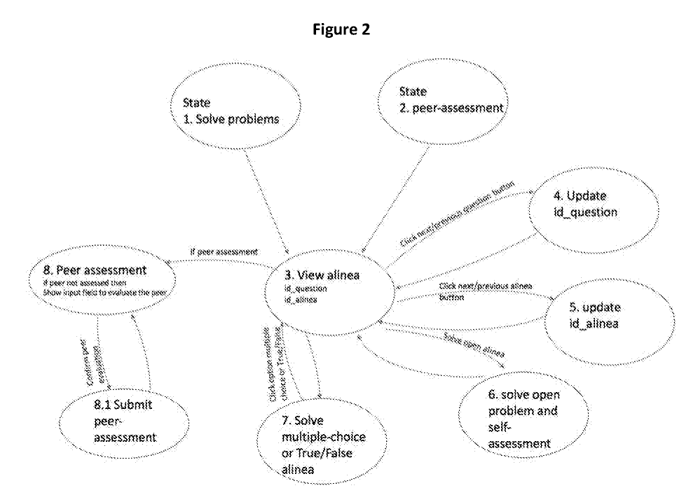

FIG. 2 shows that state diagram of the system. Students can choose to solve problems (state 1) or to evaluate the peer (state 2). In both cases, the system enters in state 3 to view current problem defined by the question and alinea ids. The student can change to next or previous question and update the information that is shown accordingly (state 4). The student can also change to next or previous alinea of a question (state 5). If the student choose to solve problems then it is possible to solve open problems and do self-assessment (state 6) or solve multiple-choice or true/false problems (state 7). If student choosed to evaluate the peers then he can evaluate the peer (state 8). In this case, if current alinea is an open problem then the student sees the work, anonymously, of another student and if it was not evaluated by the peer then it is shown an input field to introduce the points that are also used for the game of the peer. If it is a multiple choice or true/false question the peer-evaluation is made automatically by the system.

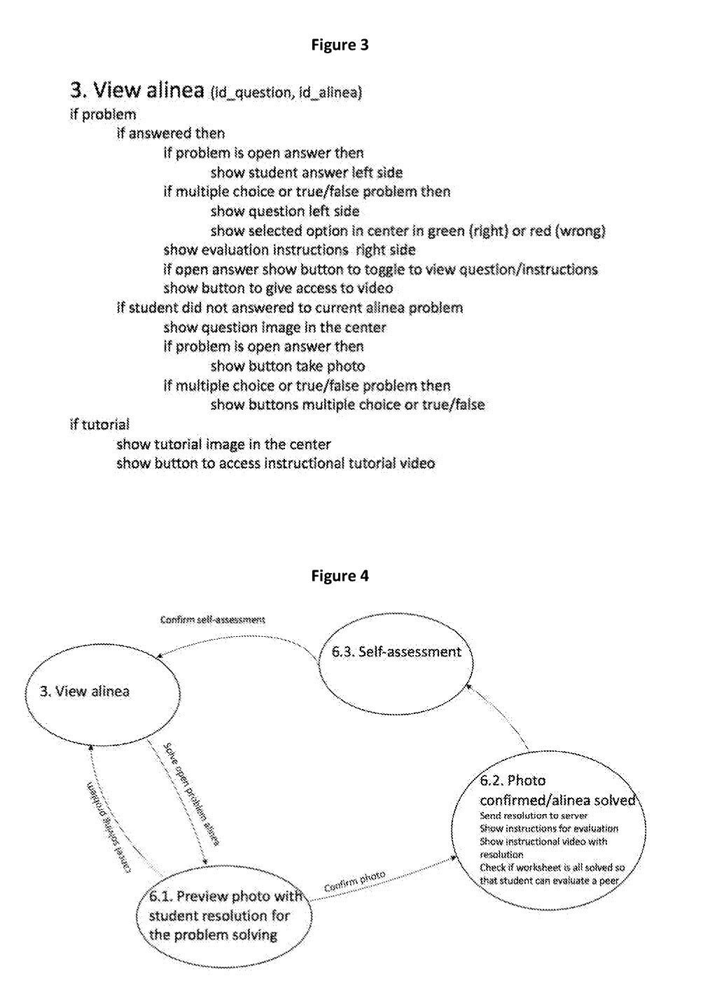

FIG. 3 shows the pseudo code for the different tasks that the system executes in the state 3 to show current question and alinea. There are two types of alineas: problem or tutorial. If current alinea is a problem and the student did already answered it then if it is an open answer problem it shows student answer in the left side. If it is a multiple choice or true/false question then it is shown on the left side the question and answered given by student is shown in the center. Evaluations instructions are shown on the right side if the screen. If it is an open answer problem show the button to toggle between instructional view and question view in the right side of the screen. Show also the button to access the video. If the student did not answered to current alinea problem then show question image in the center of the screen. If the problem is an open answer then show button to take photo of student problem resolution. If current alinea problem is a multiple choice or true/false problem then show multiple choice or true/false buttons to allow students to introduce answer. If instead of a problem if current alinea is a tutorial then show tutorial image in the center of the screen and show button to access instructional tutorial video.

FIG. 4 shows the state diagram expanded to solve open problems and self-assessment. When current alinea is a problem that is not solved, the student can click in the button to take a photo of problem resolution solved with pen and paper. In this way, analog input is scanned into the system and a preview is shown, state changes to 6.1 to preview photo with student resolution of the open answer problem. If the student confirms that photo with problem resolution is with good quality then state changes to 6.2. where photo is confirmed and open problem is solved. In this state, resolution is sent to the server. It is also shown instructions for self-assessment and button to access instructional video is also shown. It is also checked if all problems of this worksheet are solved so that this student can evaluate this same worksheet of a peer. Next, the system moves to the 6.3. self-assessment state. In this state, the student uses the instructions for evaluation to upload the self-assessment points that goes to the game. When the student confirms the self-assessment the system returns to the state 3. to view current alinea of current question.

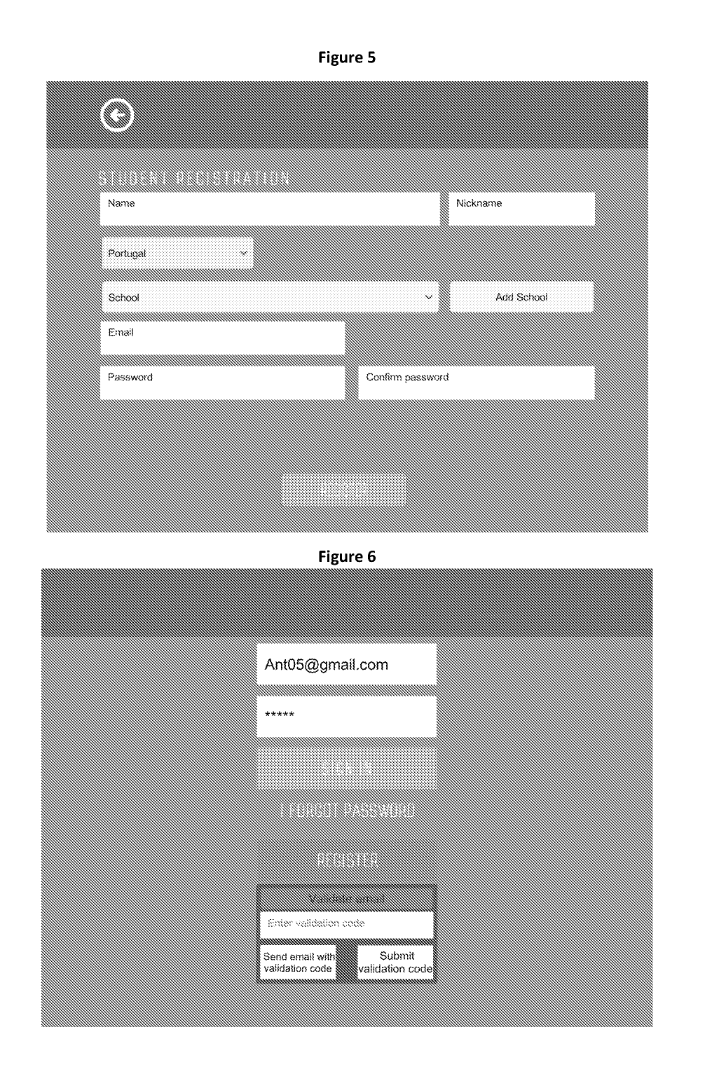

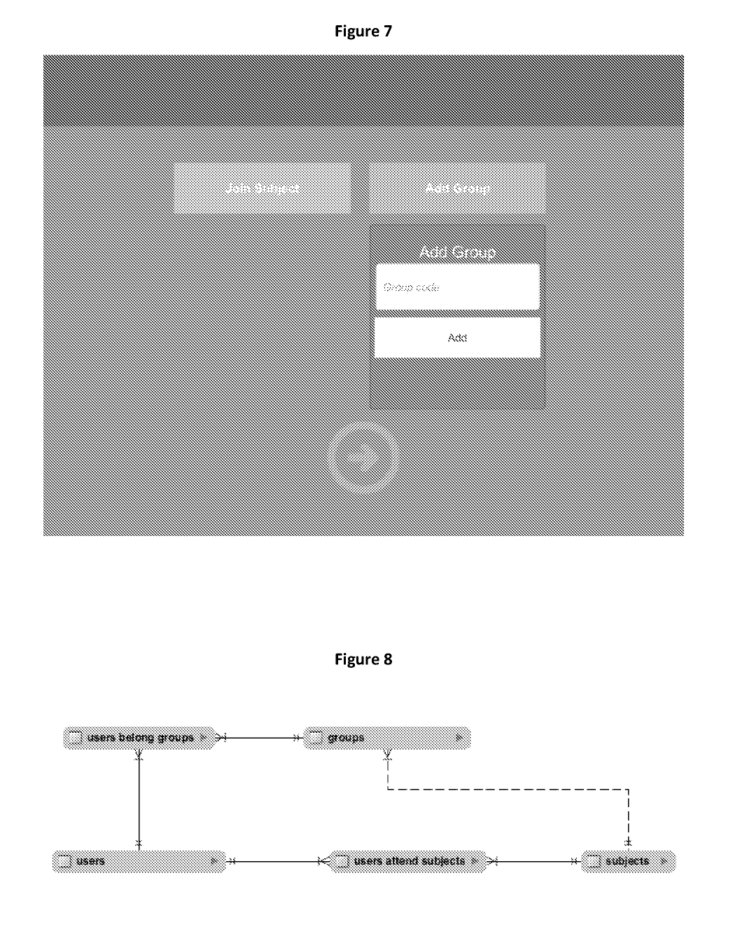

After registering (FIG. 5) and validating the email (FIG. 6) the student is asked to join an open subject or a group (FIG. 7).

In this description of invention subject relates to mathematics but other subjects, such as physics, chemistry, languages, others or to a module for training are also encompassed in the present invention.

The student registers in the platform (FIG. 5) identifying the: (i) name; (ii) nickname, that is going to be used for the chat, where he can socialize and collaborate with colleagues or other students, and for the board of points; (iii) country; (iv) school; (v) email; and (vi) password.

After successful registration, an email with a validating code is sent to the student that he uses the first time he logins to validate the email (FIG. 6).

The first time the student is also asked to add to a group or to join a subject (FIG. 7).

In the students applications, students can register to: (i) open subjects, that any student can register or (ii) groups that students can attend when they are supervised by the teacher's classroom (FIG. 7). Subjects can be open or private. If they are open, anyone can attend and watch instructional video tutorials or solve problems. If the subject is private, students can attend a private subject if they are added to a group for that subject. In the platform it is possible to have a group for an open or private subject. The teacher creates a group for a given subject, generating a group code to give to students, so that they can join the group. The teacher provides a code to the student for the subject classroom and in this way students can join the group.

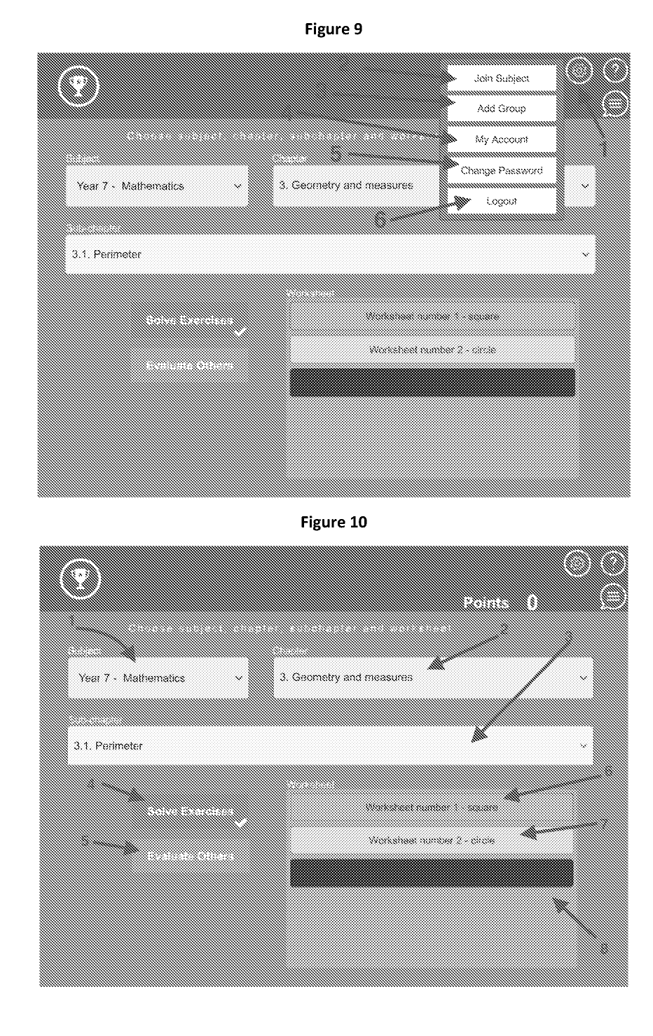

FIG. 8 represents the relational database that is in the server, to support the students' access to subjects contents by adding themselves to a group that is associated to a subject, or by joining a subject that is open to everyone and not supervised by a teacher. In this way, students can attend at any time, subjects or belong to a group that is studying a subject, by selecting the setting options where those options are available (FIG. 9).

FIG. 10 presents the working environment of the platform app for students.

The student can use the dropdowns to select the subject that wants to study (FIG. 10—number 1). In this way, using the platform the student can study different subjects of the same grade or review subjects from previous grades in the same way and integrated in the same platform. Suppose that the student is in the 11^{th} grade. The student can use the dropdown to select any subject for the 11^{th} grade. Furthermore, he can also select any subject of the 10^{th} grade, or previous grades that is available. For example, mathematics, physics, chemistry, English, foreign languages and others. In a very intuitive and simple way, he can also go to previous year and review the subjects of previous year, with the platform of this invention, using the dropdown to select the subject. In this way, the student can easily go the 10^{th} grade and review the contents for the new subjects that he is studying in the 11^{th} grade for example.

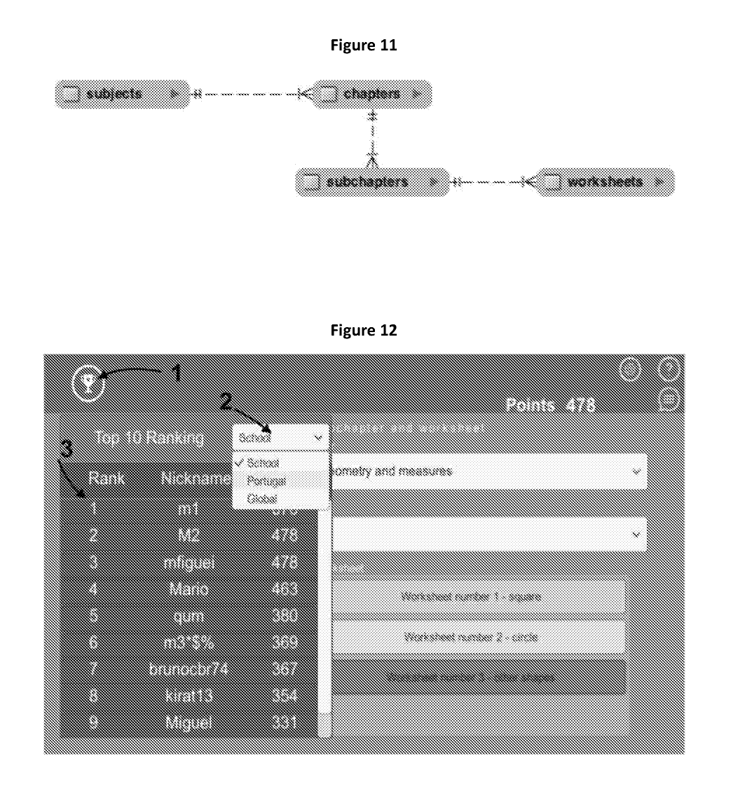

For each subject, the worksheets of tutorials and/or problems are organized like a book in a hierarchy structure of chapters and sub-chapters (FIG. 11).

After selecting the subject to study, the student selects the chapter (FIG. 10—number 2) and sub-chapter (FIG. 10—number 3) that he wants to study. Available worksheets are displayed.

The student platform implements a scheme with different difficulty levels of worksheets with the purpose of integrating all students, from low achievers to high performers. There are three different levels of worksheets complexity: beginners (green), intermediate (yellow) and advanced (red) (FIG. 10). The low-achieving students that may struggle to learn the materials covered in class, can study and repeat the materials as many times as they may need to learn. Students will have access to complex problems and activities that may provide additional stimulation for top performer students.

In the working environment of the platform of this invention, the student can see the top 10 ranking classification (FIG. 12) for the school, country or world. This is a positive stimulus to motivate students to learn. The platform provides three levels of classification. For the school, so that students can see the best results in the local community of students. The country so that there is a ranking for the nation and global for the world classification. Each student is recognized with the nickname to avoid exposure and protect his privacy. Only the teacher has information that relates the nickname to the student.

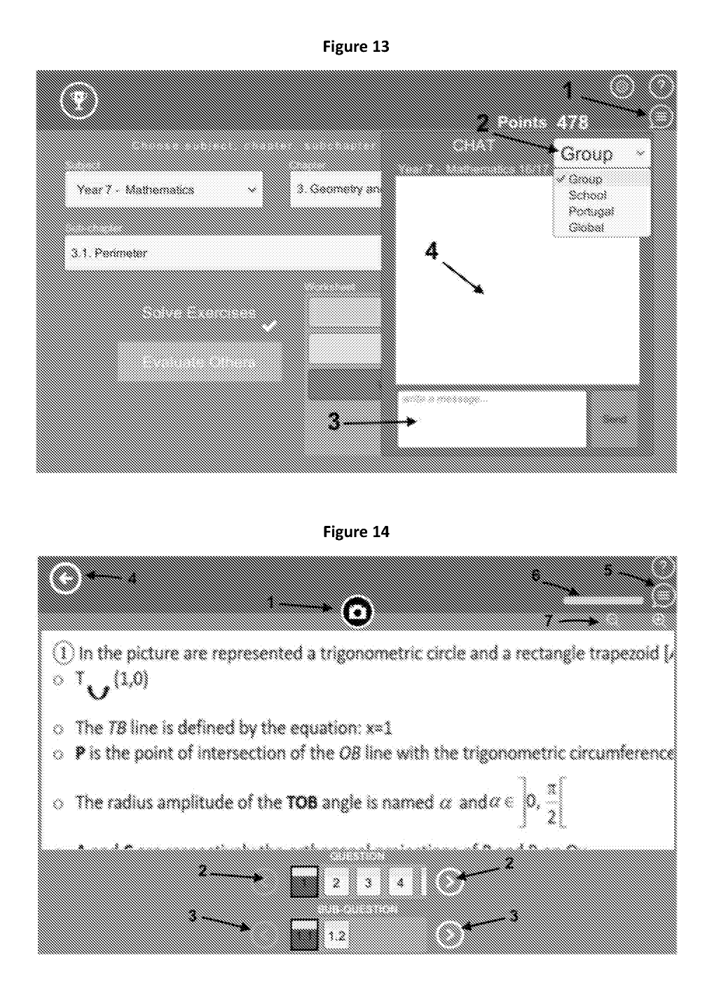

In the working environment of the student platform of this invention, there is also a chat (FIG. 13) that students can use to collaborate, exchange ideas and knowledge. To promote collaboration between students the chat is organized in four categories: group, school, country ad global. The group category enables the students from the same group/classroom to collaborate related to the same subject.

After selecting the subject, chapter and sub-chapter then the student starts to study a worksheet (FIG. 14). Each worksheet can have video tutorials, explaining any curricular content and introducing any more theoretical content, and/or exercises to be solved.

FIG. 14 shows the worksheet working environment. Next it is explained the available functionalities (FIG. 14): number 1—camera icon that the student uses to take a snapshot of the problem resolution made with pen and paper; 2—navigate to next or previous question; 3—navigate to next or previous sub-question; 4—return to the working environment; 5—go to the chat to collaborate with other students; 6—progression bar; 7—student can use fingers to zoom in and out the statement of the question.

At this point it is shown one question at a time. If the question is a problem of multiple choice, the student selects the right answer in a very straightforward way and the app can automatically identify if the answer if correct or wrong.

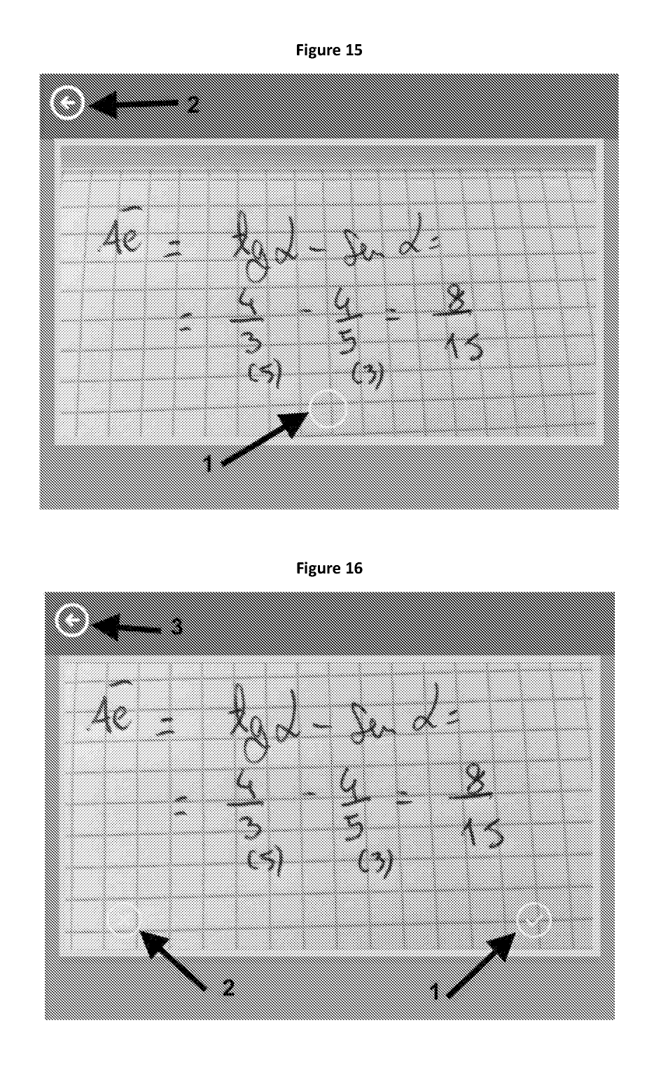

If the question is an open problem then the student makes the resolution with pen and paper and activates the camera by clicking the number 1 icon of FIG. 14. When the camera is activated (FIG. 15) the student previews the problem resolution that the student made with pen and paper, and selects the best view. Then when the student clicks in the number 1 icon of FIG. 15, it takes a snapshot of his problem resolution and the next screen (FIG. 16) shows the image of the captured problem resolution. If the picture is of good quality then the student confirms the image of the problem resolution by clicking in the number 1 of FIG. 16 and the problem resolution is uploaded to the server.

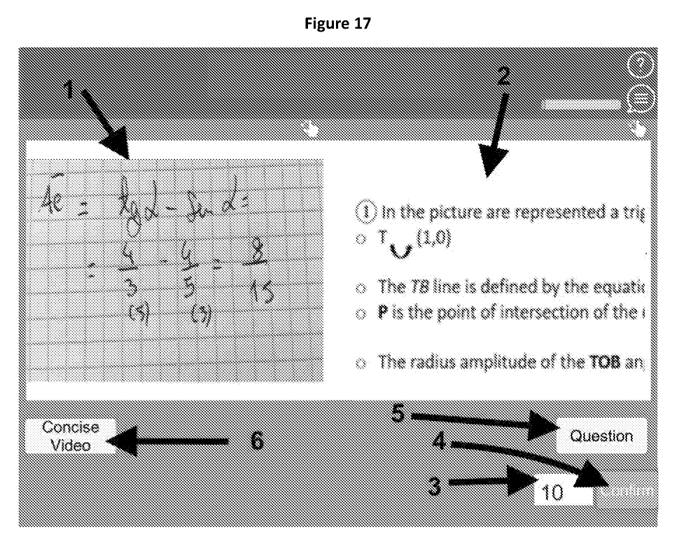

In the next step (FIG. 17), it is shown to the student the instructions for evaluation (FIG. 17—number 2) providing to the student immediate feedback that he is going to use to make his self-assessment. The student introduces the points (FIG. 17—number 3), resulting from his self-assessment judgement, that is added to his game and uploaded to the server when clicking in number 4 of FIG. 17.

This process includes game concepts to motivate the user in learning.

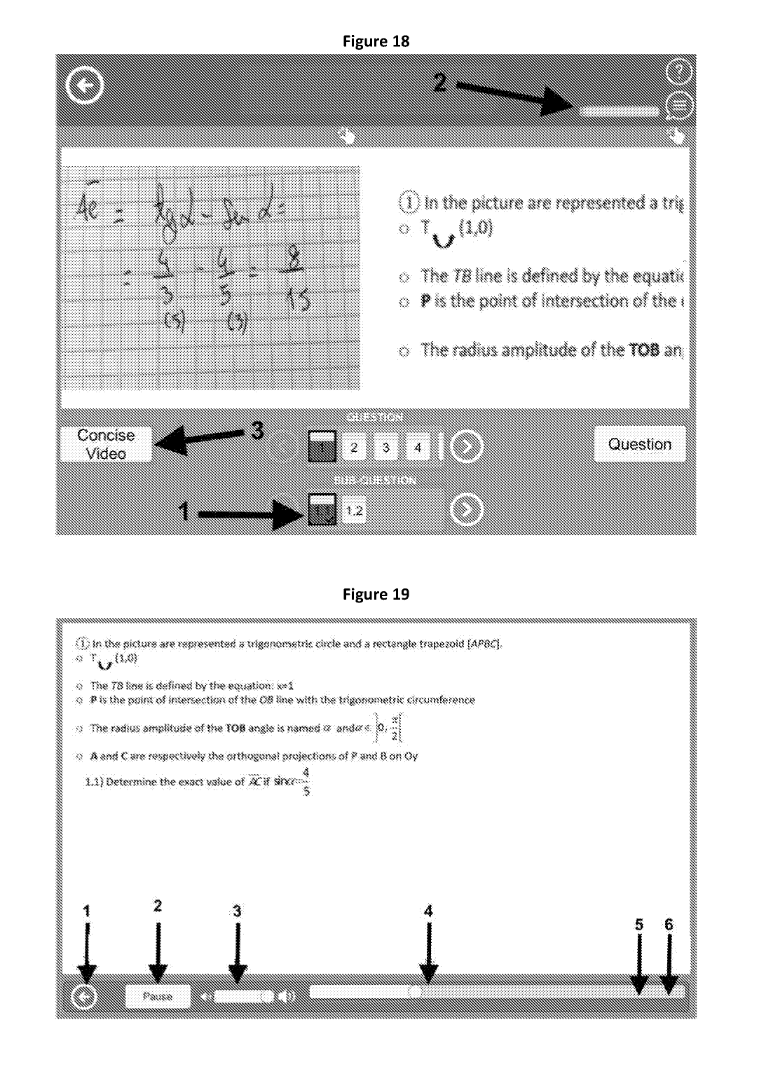

After this step, the student returns to the worksheet working environment (FIG. 18). The progression bar (FIG. 18—number 2) is updated to reflect that one more problem was solved and to give to the student information about his progress in this worksheet. The icon representing the question number 1 was also ticked (FIG. 18—number 1) to provide a visual feedback that this problem is solved. After solving a problem, the student can click in number 3 of FIG. 18 to see the detailed or/and concise video resolution of the problem so that he can study it (FIG. 19).

When the student finds it difficult to solve the problem, he can access the video with the resolution. Low-achieving students, that may struggle to learn the materials covered in class, can watch the detailed video resolution as many times as they want until they understand the subject. Top performers students can watch a concise video to know what exactly is important and enough to solve correctly a given problem.

This is a process that privileges the autonomous study, with access to exercises organized by topics, in which there is a process of scoring by self-assessment, to stimulate the motivation of the student, by the transformation of this process into a game.

Teachers will also be more confident to give homework activities to their students. It is known that it is important to assign homework, to help struggling or underachieving students to learn the material covered in class, to ensure that the material is stored in students' long-term memory, or to provide additional stimulation for high performers. Teachers know that students can do the homework autonomously and they do not need to spend classroom time to solve problems sent to do at home.

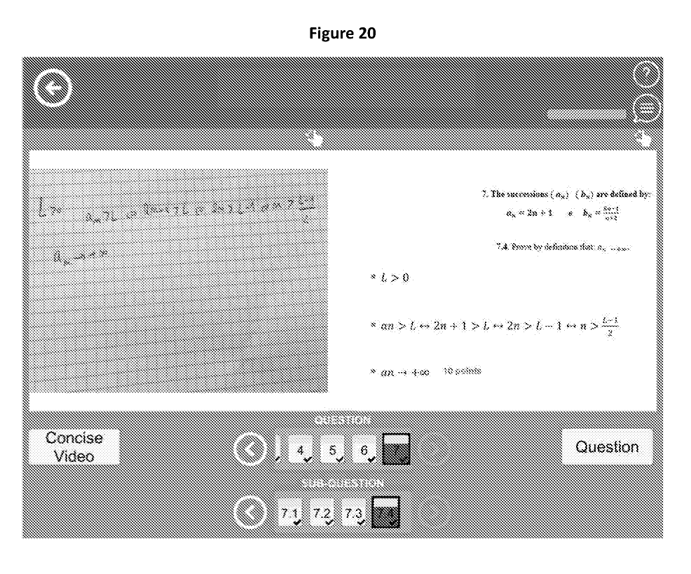

When the student completes solving all the problems of a worksheet (FIG. 20) then he can evaluate the same worksheet of a peer. In this way, the student can study by solving problems or by revisiting the subject when he is evaluating the work of another student. Inclusion of peer assessment contributes to the promotion of formative learning, fosters learners' independence and responsibility for the learning process.

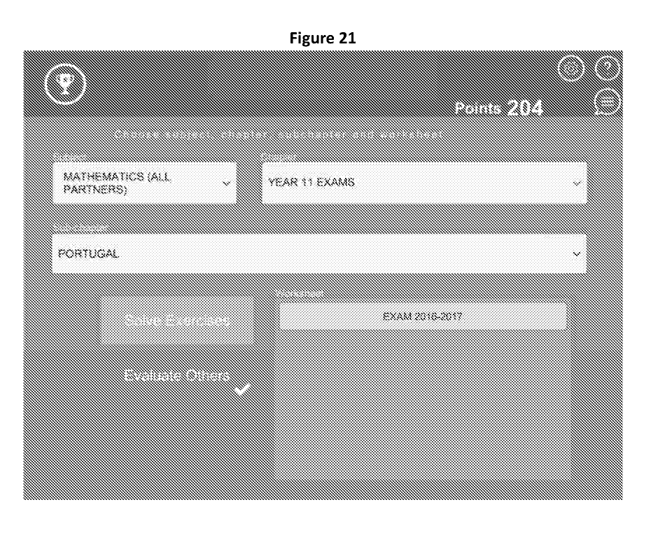

When the student clicks the button to evaluate other student (FIG. 21) it is shown the possibility to evaluate the same worksheet of a peer, because this student already solved this worksheet.

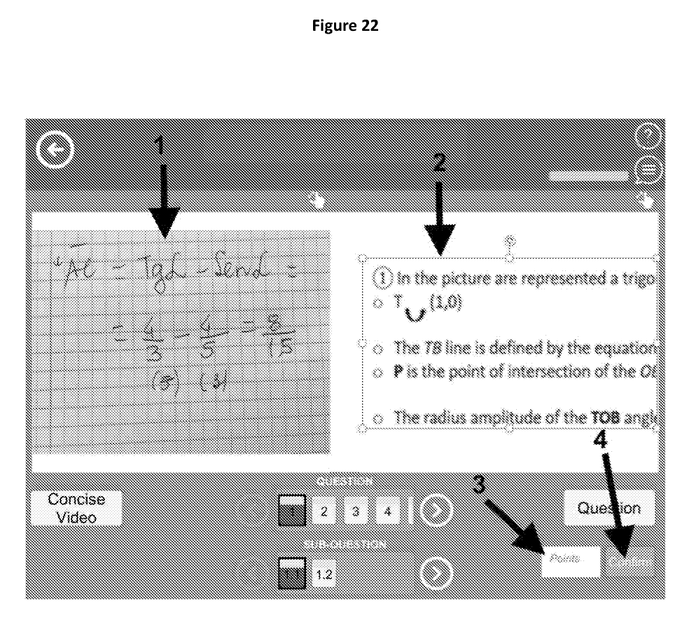

FIG. 22 shows the worksheet working environment setup for peer-assessment, which is anonymous. It is shown in the left-side area (FIG. 22—number 1) the peer resolution of this problem and in the right-side area (FIG. 22—number 2) the instructions for evaluation. The student introduces the points (FIG. 22—number 3) that are given to the peer game and confirms (FIG. 22—number 4) to upload to the server.

The student in this way can study again this problem by watching the resolution of a colleague and reviewing the instructions for evaluation and the detailed/concise video.

Inclusion of peer-assessment contributes to the promotion of formative learning, student's independence and responsibility for the learning process.

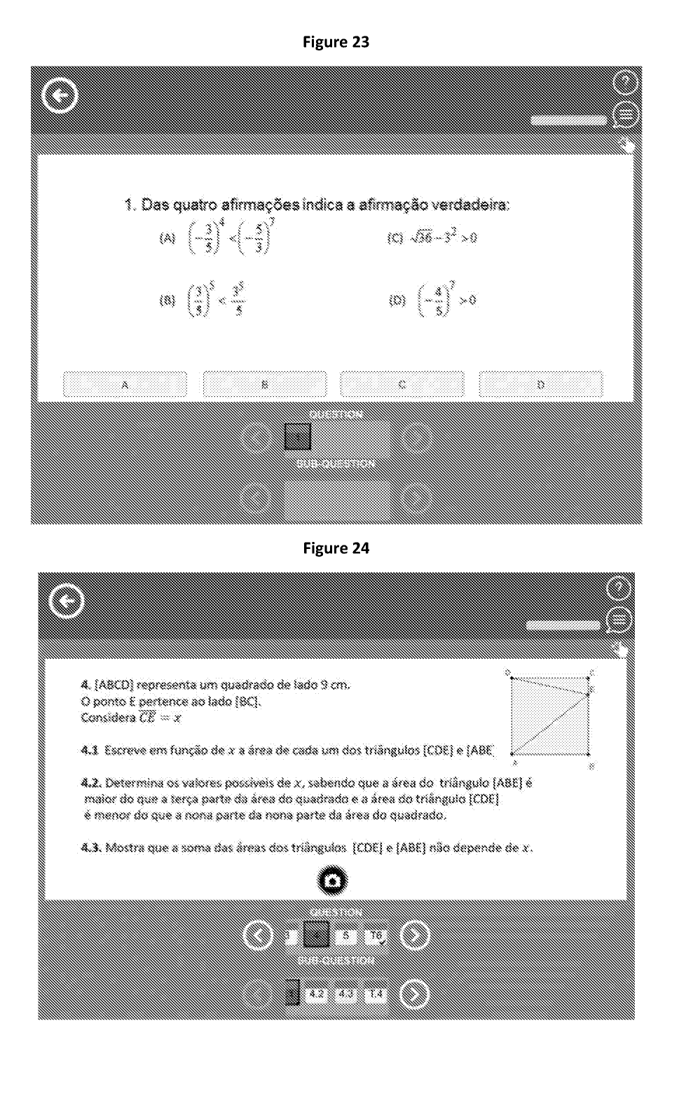

In the platform of this invention, a worksheet can have multiple-choice questions (FIG. 23) including true/false questions or open answer like the previous ones.

The worksheet can have any number of video tutorials or problems by any order. FIG. 24 shows a worksheet with 5 questions and one tutorial T6 (tutorials are identified in the navigation panel with a T). Problem 4 has 3 sub-questions of problems and another video tutorial T.4.

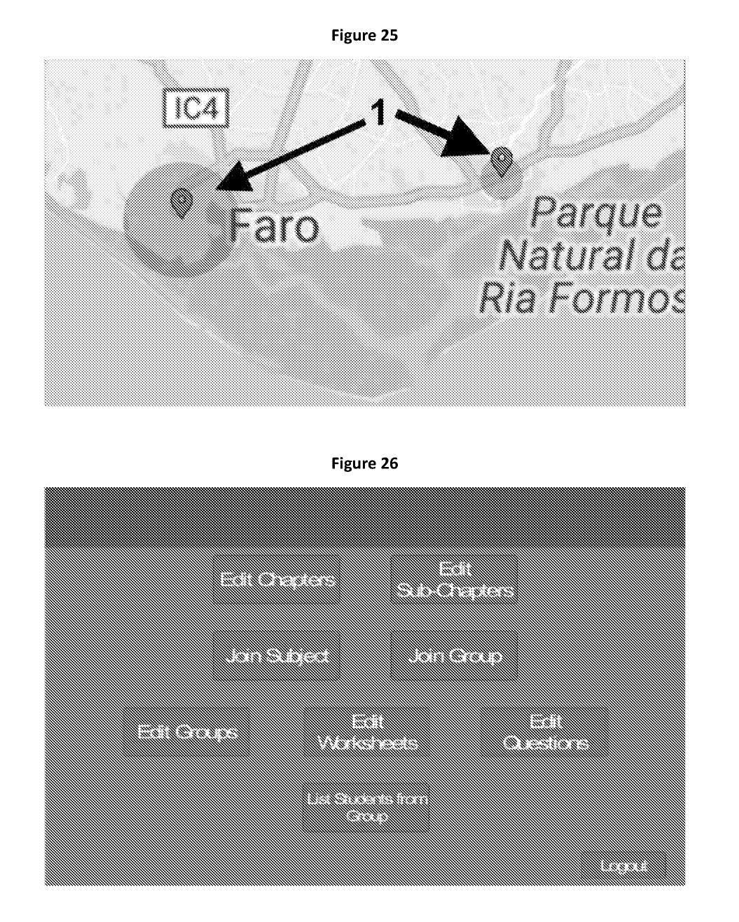

In the platform of this invention it is also possible to have worksheets assigned to a geographic location with an area of influence/activation (FIG. 25). When the student is inside the area of activation it is used augmented reality to activate the worksheet and the student can watch the tutorials or solve problems of that worksheet that is related to the location.

This invention is an ecosystem that includes also a platform for teachers that enables them to make content for students.

Teachers uses their platform (FIG. 26) to create the curriculum for a subject, create the worksheets, upload video tutorials, questions, instructions for the evaluation and videos with problem resolutions. This application lets also teachers follow the e-portfolio of each student.

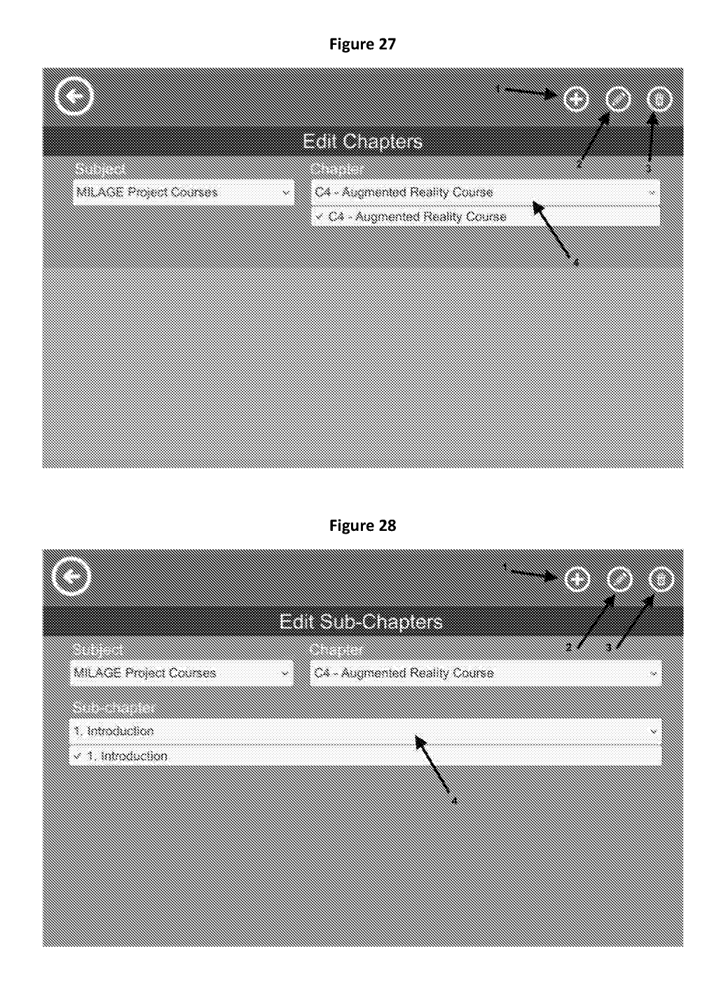

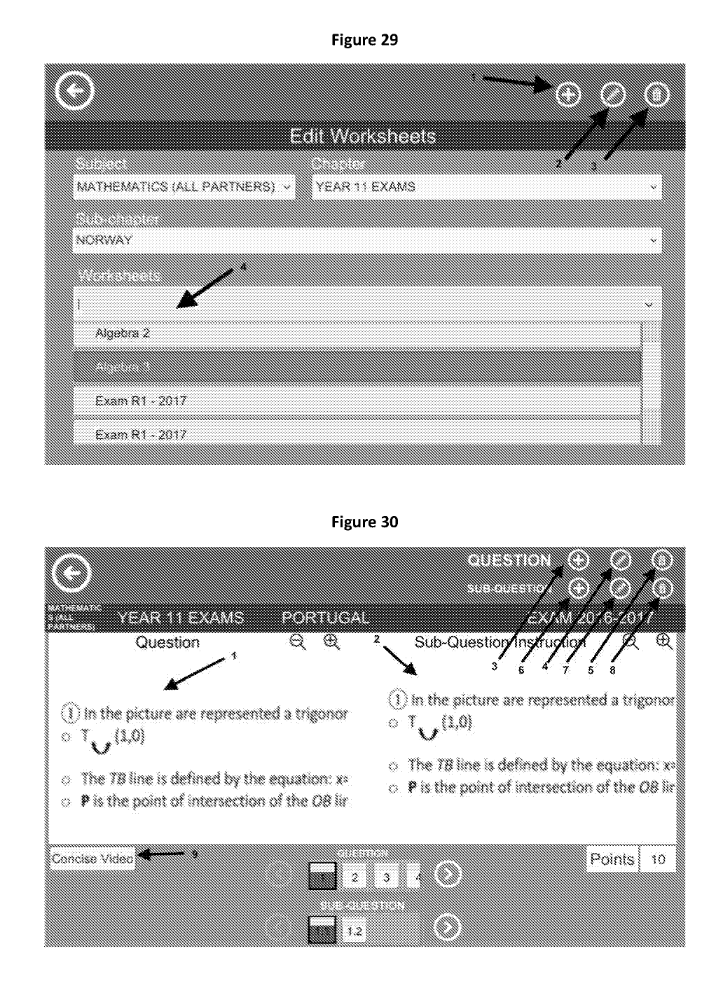

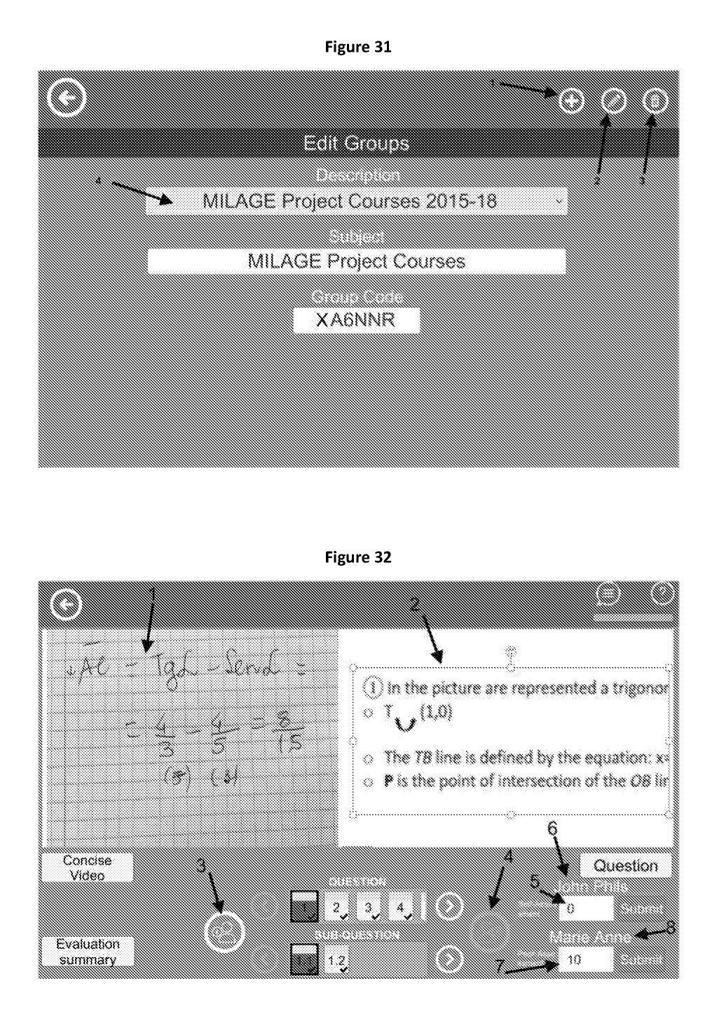

The teacher can create the curriculum for a subject creating the chapters (FIG. 27) and the sub-chapters (FIG. 28), building a structure that accommodates the worksheets (FIG. 29) that makes available to students the instructional video tutorials and/or the problems to be solved by students with video resolution of problems (FIG. 30).

The teacher can easily upload/edit video tutorials questions (FIG. 30) and for each sub-question the teacher chooses if it is a multiple choice, true or false, or open sub-question, the number of points, the instructions for the evaluation and the videos, detailed and/or concise, with the resolution of the sub-question. Teachers can upload multiple choice, true or false, or open questions for students with any order; no limitation exists about this.

In this way, the teacher can create worksheets of video tutorials or problems that students have to do to practice and solve the problems using a mobile device or a computer system. These tutorials and problems are uploaded to the server. This data is later available to the students' platform where students have access to the different tutorials and questions and the videos with the problem resolutions.

This also enables teachers to produce the contents and make them available to their students. An alternate way to produce activities and problems is to use the textbook companies provided materials, when lecture videos are provided, and exercises that are readily available for teachers and can be uploaded in this platform.

Teachers can also use their own produced materials or textbook company's contents to create their own activities targeted to the particular needs of each class and individual student. We believe that this can be very motivating for students and it also helps in delivering lectures, hands-on activities and customized study modules. This is a main advantage of this platform for education because teachers can tailor activities to each student.

The teacher can create a group of students for a subject (FIG. 30). Students register using the group code. In this way, the teacher does not have to register each student individually. The process is simplified for the teacher since the students register and they are connected automatically to the teacher group.

In the platform of this invention, the teacher can see the e-portfolio of each student (FIG. 32). The teacher can see the snapshot of every resolution made by the student that was uploaded using the platform for students.

The teacher has access to the self-assessment of the student (FIG. 32—number 5) and can change those points, by entering the new evaluation in the points box and confirms to change the self-assessment evaluation.

The teacher can also see the name of the student that made the peer-assessment (FIG. 32—number 8). The teacher can change the peer-assessment (FIG. 32—number 7) by introducing the new value and confirm it.

In this way, the teacher can at any time see the work of his students and evaluate their progress. It is also possible to build an e-portfolio book for each student compiling all the work of the student in the group.

### BIBLIOGRAPHY

Andrade, H. and Du, Y. (2007), “Student responses to criteria-referenced self-assessment”, Assessment and Evaluation in Higher Education, vol. 32, no. 2, pp. 159-181.

Attali, Y. & Arieli-Attali, M. (2015). Gamification in assessment: Do points affect test performance?. Computers & Education, 83, pp. 57-63.

Boud, D. and Falchikov, N. (2007), Rethinking assessment in higher education. London: Kogan Page.

Hsu, S. H., Chang, J. W. & Lee, C. C. (2013). Designing attractive gamification features for collaborative storytelling websites. Cyberpsychology, Behavior, and Social Networking, 16(6), pp. 428-435.

Wood, L. C., Teräs, H., Reiners, T. & Gregory, S. (2013). The role of gamification and game-based learning in authentic assessment within virtual environments. In Higher Education Research and Development Society of Australasia (HERDSA), AUT University, Auckland, New Zealand.

Zichermann, G., & Linder, J. (2010). Game-based marketing: Inspire customer loyalty through rewards, challenges, and contests. Hoboken, N.J.: Wiley.

Other publications (made by the inventor):

Martins, C., Ribeiro, C., & Figueiredo, M. J. G. (2017). The Use of Milage Learn+ APP: A preliminar study from training course for adults applying university. Presented in the I Congreso Virtual Internacional y III Congreso Virtual Iberoamericano sobre Recursos Educativos Inovadores. Madrid: Fundación General de la Universidad de Alcalá, 11-17 Dec., 2017.

Godejord, B. J., Godejord, P. A., & Bostad, R. (2017). UBIQUITOUS TECHNOLOGY IN EDUCATION CONTEXT: AN EVALUATION OF A MOBILE LEARNING APPLICATION, ICERI2017 Proceedings, pp. 4898-4904. ISBN: 978-84-697-6957-7. doi:10.21125/iceri.2016.1970

Figueiredo, M. J. G. (2017). Autonomous Learning, Self and Peer assessment with the MILAGE LEARN+ app for Mathematics. In Geogebra Global Gathering, Linz, Austria, 18-20 July.

Martins, C. & Figueiredo, M. J. G. (2017). The use of MILAGE LEARN+ app for Computer Programming Learning: A Preliminary Study Concerning Self-Determination Variables. In Interdisciplinarity in Social and Human Sciences International Congress, Faro, Portugal, 11-12 May.

Figueiredo, M. J. G. (2017). Matemática com a app MILAGE APRENDER+. In X Conferëncia Internacional de TIC na Educação—Challenges 2017, Braga, Portugal, 8-10 May.

Figueiredo, M. J. G., Bidarra, J., González-Pérez, A. & Godejord, B. (2017). Promoting autonomous work of students with the MILAGE LEARN+ APP. 11th annual International Technology, Education and Development Conference, Valencia, Spain, 6th, 7 - 8 Mar., 2017.

Figueiredo, M. J. G., Godejord, B., Rodrigues, J. I. R. & González-Pérez, A. (2016) MILAGE APP—Mobile Learning of Mathematics. In Proceedings of EDULEARN16 Conference, Barcelona, Spain, 4-6 July, pp. 8863-8872.

Figueiredo, M. J. G. (2017). MILAGE Learn+ app promoting autonomous & student-centered learning with augmented reality and game books, Media & Learning News, Published by the Media & Learning Association., February, pp. 3

Figueiredo, M. J. G., Godejord, B., & Rodrigues, J. I. (2016). The Development of an Interactive Mathematics APP for Mobile Learning. Proceedings of 12th International Conference on Mobile Learning 2016, Vilamoura, Portugal, 9-11 April, pp. 75-81.

1. A learning gamified platform system for an electronic device comprising:
a server for reading medium and storing the user information, progress, scoring, portfolio and other relevant data of the user,
a communication tool for the server communication via Internet with at least one electronic device, at least one electronic device with Internet access,
wherein said electronic device having installed the learning gamified platform having registration means for the registration and definition of at least one game-user profile and skill level and setting, recording and displaying the user's current and historic score, e-portfolio and performance and at least one teacher-user profile allowing a teacher-user or tutor-user to follow the progress of the game-user, and said platform integrates:
Analog input—students solve problems with pen and paper and using the electronic device it is taken a photo that scans the student answer into the platform,
A gamification scheme is implemented to motivate students for learning,
Instructional Videos to provide feedback and for learning
Different difficulty levels of problems, and
Different levels of explanation videos are available to integrate all students and in this way students that are low performers can start with beginner levels of problems and watch detailed instructional videos, as well as, more advanced students can be motivated by learning by solving advanced problems and watch concise instructional videos,
Self and peer-assessment to promote learning and auto-regulation.

2. The system of claim 1 wherein the game-user defines a profile and registration by introducing the complete name, nickname, country, school name, email and password to register in the platform.

3. The system of claim 1 wherein the game-user selects a group to join that is supervised by a teacher by entering the group code that is provided by the teacher, or the student selects an “open” subject group.

4. The system of claim 1 wherein the game-user accesses the configuration options menu by clicking in number 1; 2—button to join an open subject; 3—button to add a group code to join a group/classroom of a subject that is supervised by a teacher; 4—option to have access to students account in the platform where he can change the name, nickname, country and school; 5—option where student can change his password; 6—option to logout from the platform app.

5. The system of claim 1 wherein the game-user chooses the subject to study by clicking in the dropdown to select the subject to study (number 1); the chapter of study by clicking in the dropdown number 2 and the sub-chapter of interest by clicking in number 3, and the game-user selects worksheets with tutorials and/or questions of problems to solve (clicking button number 4) or by assessing a peer (clicking button number 5).

6. The system of claim 1 wherein the game-user chooses worksheets with different degrees of difficulty: beginner (color green—number 6), intermediate (color yellow—number 7), and advanced (color red—number 8).

7. The system of claim 1 wherein the game-user selects the top 10 ranking (clicking button number 1) for the school, country or world classification by clicking the dropdown button 2. The list of students in the rank is shown in the number 3 area.

8. The system of claim 1 wherein the game-user uses a chat to collaborate in the group, school, country or globally (clicking in the dropdown button 2), and can send messages by clicking in number 3, thus messages are shown in zone 4.

9. The system of claim 1 wherein the game-user solves problems from the worksheet: Number 1—camera icon that the student uses to take a snapshot of the problem resolution made with pen and paper; 2—navigate to next or previous question; 3—navigate to next or previous alinea; 4—return to the working environment; 5—go to the chat to collaborate with other students; 6—progression bar; 7—student can zoom in and out the statement of the question.

10. The system of claim 1 wherein the game-user takes a snapshot of the problem resolution by clicking in 1; if clicking in 2 then the student returns to the worksheet working environment and problem solving is canceled; when clicking in 1, the student confirms and the snapshot of the problem resolution is uploaded to the server; if clicking in 2 then the student returns to the screen of FIG. 15 and can take another snapshot; and if clicking in 3 the student returns to the worksheet working environment.

11. The system of claim 1 wherein the game-user makes his self-assessment by using the instructions for evaluation (number 2); the game-user introduces the points (number 3) that are added to its game and confirms by clicking in 4 to upload those points to the server; button to toggle question/evaluation view (number 5), or button to watch the instructional video (number 6).

12. The system of claim 1 wherein the game-user returns to the worksheet working environment and the problem 1 is ticked as solved (number 1), the progression bar is updated (number 2) and the student can see now a detailed and/or concise video with the problem resolution (number 3), and he can evaluate the same worksheet of a peer anonymously: 1—The peer resolution of this problem; 2—instructions for evaluation; 3—points for the peer game; 4—confirm button to upload the peer-assessment.

13. The system of claim 1 wherein each worksheet can have multiple-choice questions, can have any number of questions, and each question can have any number of sub-questions being further possible to combine tutorials, open and multiple choice question by any order, and Tutorials are identified in the navigation panel with a T.

14. The system of claim 1 wherein each worksheet can be assigned to a location with an area of activation (number 1), and by using Augmented Reality when the student is inside the area of influence of the worksheet, it is activated and the student can view the tutorials or solve problems that can be related to the place where it is located.

15. The system of claim 1 wherein the teacher-user can create (number 1), edit (number 2) or delete (number 3) sub-chapters of a subject that is selected using the dropdown (number 4), worksheets with problems or tutorials with three levels of difficulty: beginner, intermediated and advanced that is selected using the dropdown (number 4).

16. The system of claim 1 wherein the editor where the teacher-user can edit/upload questions and sub-questions to the worksheet: 1—Question statement; 2—Evaluation instructions, and the teacher-user can create (number 3), edit (number 4) or delete (number 5) questions, or create (number 6), edit (number 7) or delete (number 8) sub-questions, being 9—Button to watch the instructional video.

17. The system of claim 1 wherein the teacher-user can see the e-portfolio of the student: 1—problem resolution of student displayed in number 6; 2—instructions for evaluation; 3—navigate to previous student of the group; 4—navigate to next student of the group; 5—self-assessment points; 6—name of current student of the group; 7—peer-assessment made by the student indicated in number 8.
